(19) United States
(12) Patent Application Publication
(10) Pub. No.: US 2025/0367793 A1
(43) Pub. Date: Dec. 4, 2025

(54) Pliers

(71) Applicant: ATE INTERNATIONAL LIMITED, Leicestershire (GB)

(72) Inventor: Nigel Buchanan, Fife (GB)

(73) Assignee: ATE INTERNATIONAL LIMITED, Leicestershire, EA (GB)

(21) Appl. No.: 18/854,176

(22) PCT Filed: Apr. 4, 2023
(86) PCT No.: PCT/GB2023/050901

§ 371 Date: Oct. 4, 2024

(30) Foreign Application Priority Data
Apr. 4, 2022 (GB) 2204892.0

(51) Int. Cl. B25B 7/12

(52) U.S. Cl. CPC B25B 7/123

(57) ABSTRACT

Everyway Pliers 1 comprising fixed and pivotal gripping jaws 206, 301 operated by fixed and moving handles 200, 400 wherein a force triangle 800 is formed with its base 801 between the pivotal jaw 300 actuation pivot pin 60 land the fixed handle 200 to pivotal strut 500 pivot pin 601, the triangles apex 802 formed within the pivotal strut outer pivot bore 502 and moving handle central pivot point 402. As the operator clenches CF the moving and fixed handle grips 413, 212 said triangles apex 802 is propelled towards said triangle base 801, forcefully elongating said base 801, further forcefully rotating the pivotal jaw 300 towards the closed position around the pivotal jaw pivot bore 302, the combination of said rotational and elongation closure forces employed provides extremely robust gripping jaw 301, 206 closure, by one or smaller hands. Optionally incorporating interchangeable push fit jaws 900, utilizing near identical curved locking blade and abutment profiles 901, 902 with strong magnets 905 located within the jaw stub blade channel 903 tips, providing substantial initial interchangeable jaw 900 retention.

### FIELD OF INVENTION

The invention relates to hand operated gripping tools, that are adjustable within the range of the jaws of the tool. One form of hand operated gripping tool are pliers of the type generally referred to as locking pliers or vice grip pliers as they are colloquially known. A further, normally separate, hand operated gripping tool, requiring less clamping pressure upon the workpiece without a locking feature, are water pump pliers as they are colloquially known.

### BACKGROUND TO THE INVENTION

Existing “vice grip” type pliers or water pump pliers are normally made by a method termed loss wax moulding or investment casting whereby the sometimes intricate jaw shapes/gripping profiles are first made in wax that is then coated in a refractory shell by dipping or spraying. Then during the casting process the wax is burnt away and the shell mould filled by the metal casting material. The smoke created is environmentally a problem, the particulate is sometimes filtered out but the gasses created are normally just vented to the atmosphere, as in China or India. Because of environmental concerns this method is all but redundant in the likes of USA or Europe for large scale manufacture, but because of costs, manufacture by investment casting continues elsewhere to support the worldwide demand of yearly sales in well in excess of 10M for these tools, this remains a major environmental problem.

Existing locking pliers such as U.S. Pat. No. 9,855,642 Wu and US2015273664(A1) Skodje, Calgar and U.S. Pat. No. 9,855,642 Wu comprise of two robust handles connected to two robust jaws, and a locking mechanism connected to the two jaws. The handles can be squeezed to close the jaws. The locking member is attached to an over centre linkage which when utilized prevents the lower handle from pivoting from its closed configuration until opened, retaining the jaws in a closed position. The clamping width of the jaws being typically pre-adjusted by an adjustment screw against the adjustable base of its strut within the fixed handle, the adjustment screw further determining the clamping pressure exerted upon the clamped workpiece. As the clamping pressure requires to be preordained it can take several attempts to correctly adjust the screw to the required position in order to clamp the workpiece in the optimum way. The clamping width of the jaws once set by the adjusting screw is finite, with any movement, vibration or relaxation of the clamped material normally resulting in the failure of the clamping action. This is most prevalent when the device is used to initially clamp vehicle bodywork parts during the panel-beating process prior to welding or bolting the panels being worked on, as inadvertent over pressure applied by the clamping jaws usually results in the damage or distortion of the clamped parts. The further fact that the locking mechanism requires to go “over cam” during the locking procedure results in the clamping pressure being slightly released. Due to the considerable initial width between the fixed and moving handles, the initial closure operation is normally a two handed affair. In addition the opening of the pliers if the clamping pressure is anything but low can be likened to a mousetrap going off as the clamping pressure is released.

U.S. Pat. No. D742,194, 2015 Nov. 3 Engel, Albrecht shows a set of pliers having a toothed strut with a locking mechanism attached to one operating arm, as the arms are closed the teeth “ratchet” past the lock. As the operating arms are not designed to resiliently deform during robust operation, the toothed arc of the strut remains in substantially the same locking angle relative to the locking mechanism.

EP2818280(A2) 31 Dec. 2014 Buchanan comprises pliers or clamps having a bow or arcuate portion in order to permit limited flexing of one of the handles. A pivotal strut is retained between the handles, the strut being slidably held in a channel within one handle and pivotally held within the other handle, the pivotal end of the strut within the fixed jaw handle having a toothed arc which acts with a switch and further pawl to lock or unlock the handle positions relative to one another. The compression of the handles closing the gap between the fixed and moveable jaws, the moveable jaw sliding up a wedge shaped clamp bar portion until the jaws robustly contact the workpiece, the further operation of the handles resulting in the clamping of the workpiece, the resilient arcuate portion acting to impose a limited sprung grip upon the workpiece, further usefulness imported by the locking action of the pawl teeth upon the strut arc teeth when the pawl is switched into its ratchet locking position retaining the handles substantially in their closed position providing a limited sprung grip upon the workpiece. The arc of the toothed strut in conjunction with the corresponding toothed arc of the pawl being capable of compensating for the changes in angles of one handle relative to the other as the resilient portion flexes as differing pressures are applied to the handles during use, the pawl is activated into either a locking or non-locking position by a further separate “rocker” switch incorporating a spring and plunger mechanism which acts upon the pawl, this tool is quite complex to manufacture giving it a relatively high manufacturing cost furthermore the moving jaw and clamp bar movement requires to be kept very clean and lubricated in use to prevent the mechanism sticking.

In order to make these pliers more ergonomic they can incorporate glued or moulded on rubber like grips which make the end of life tools difficult to recycle.

It is an object of the present invention to at least partially alleviate the above mentioned disadvantages, or to provide a cost saving alternative to existing products.

### SUMMARY OF THE INVENTION

The present invention has been designed not only to clamp or grip the workpiece without crushing, but to be far faster and simpler to use in particular by small hands with an improved ergonomic grip and with far less global environmental impact by the fundamental design change to allow a stamped flat metal laminate type construction slotted into simply locked or removable rigid plastic moulded handles, capable of being low cost manufactured with minimal environmental and logistical impact within every industrialized nation worldwide while still being commercially viable.

The present invention comprises fixed and pivotal jaws incorporating gripping faces within said opposing jaws for the clamping of the desired workpiece, a fixed and moving handle and a pivotal strut positioned between said handles, the strut being pivotally retained within set points within the adjoining fixed and moving handles by pivot pins instead of as in prior art struts, which require a moving or adjustable strut end within the moving or fixed handle portions. An arc shaped resilient portion or alternately a strong compression spring held laterally around apposing overlapping lengthwise members incorporating abutment profiles which act against the said strong compression spring ends, the overlapping lengthwise members being capable of sliding against one another as in use the compression spring is compressed or released, the chosen level of resilient compression resistance, is in best practice incorporated within the moving handle actuation arm portion, such that when operating the present pliers, by virtue of the employed, arced resilient portion or compression spring this can impart an extremely practical strong sprung clamping pressure upon the clamped workpiece by the gripping face of the jaws.

According to the present invention there is provided a set of everyway pliers comprising a fixed handle incorporating a fixed handle grip within its distil end and a fixed head portion incorporating the fixed gripping jaw within its proximal end, said fixed head portion further incorporating a pivotal jaw pivot pin bore and a fixed head pivot pin around which a pivotal jaw incorporating the pivotal jaw gripping profile can swivel towards closure within the same plane when operated by a gripping force between the fixed and moving handle grips, a strut is further pivotally mounted by pivot pins between the fixed handle and moving handle. The moving handle further pivotally attached to the pivotal jaw at its moving handle proximal end by the pivotal jaw actuation pivot pin, whereby a scalene or Isosceles type triangle is formed with its base situated between the pivotal jaw actuation pivot pin and the fixed handle to strut inner end pivot pin, the fixed handle portion and the inner end of the pivotal strut pivotally incorporating said fixed handle portion to strut pivot pin, the triangles apex formed within the pivotal strut outer end pivot bore and corresponding moving handle to strut pivot pin bore and further incumbent triangle apex pivot pin. During use as the operator clenches the moving handle towards the fixed handle portion, said triangles apex pivot pin is propelled towards said triangle base forcefully elongating said triangle base line. The moving handle to strut outer end pivot pin bore is positioned as near as practical to the moving handle proximal end within the moving handle grip such that as an initial clenching force is applied between the fixed and moving handle grips, this firstly rotates the moving handle grip distil end around the triangle apex pivot pin towards the fixed handle distil end, simultaneously rotating the moving handle actuation arm and pivotally attached pivotal jaw outwards from the fixed handle. This procedure enables the jaw gripping profiles to easily and promptly first grip the workpiece, any further robust clenching force applied laterally compressing the ends of the actuation arm compression spring or resilient bowed portion, not unlike the drawing of a longbow, this combination of rotational and elongation closure forces employed provides a very efficient heavy duty pliers closure function, that can be because of the now greatly reduced distance between the said fixed and moving handles, be operated by one hand and smaller hands. A similar overall length and jaw opening set of typical prior art (for example 10 inch 25.4 cm), “vice grip” pliers having a handle tip opening of approximately 175 mm, whereas similar useful jaw opening dimension pliers according to the present invention can be less than 80 mm enabling single handed use by even small hands.

The present invention is further characterized by an intuitive switch locking/unlocking mechanism utilizing less parts than previous pliers type tools, comprising a pivotal strut incorporating a toothed arc interacting with a switch. The present rocker switch incorporates a single piece locking, ratcheting or disengaged toothed mechanism according to its chosen orientation, this can be utilized as required to engage with the teeth of the toothed strut arc to positionally lock as required the same, thereby locking the clamped workpiece within the jaw portions, or alternately disengaging the switch teeth from the strut toothed arc releasing the workpiece from the jaws, according to the pivotal rocker switch chosen orientation.

According to the present invention the fixed and pivotal gripping jaws can be usefully locked in the required clamping position upon the workpiece, in best practice by a pivotal strut having an outer end toothed arc, pivotal within the moving handle internal framework, being locked or unlocked according to the corresponding toothed rocker switch chosen orientation within said moving handle internal framework. The strut inner end pivotally retained upon the opposing fixed handle by the fixed handle to strut pivot pin. As the handles are closed relative to one another, the pivoting outer end of the strut incorporating the toothed arc, ratchets against the resiliently biased corresponding rocker switch teeth. In order to provide as versatile a device as possible the operator can apply finger pressure to the trigger profile as they operate the pliers in order to overcome the locking mechanism during any jaw closure. After gripping use, in order to overcome the safety locking mechanism they firstly clench the fixed and moving handle grips to the same or greater initial locking clenching force then operate the rocker switch trigger profile in order to smoothly and safely release the jaws gripping force upon the workpiece.

As it is commercially prudent to have a ratchet like clicking noise to accompanying the jaw closure and locking procedure, this is provided by interaction between the resiliently biased rocker switch toothed arc teeth with the corresponding pivotal strut toothed arc teeth, as the pivotal strut rotates during the closure procedure, around the moving handle central apex pivot pin against the resilience of the pivotal strut main spring. The rocker switch being resiliently biased towards the closed position by a very cost efficient U shaped single wire, rocker switch closure spring.

The present invention further incorporates clamping widths within its specification that are automatically adjusted, the locking pressure can be further be usefully determined by the operator by the straightforward gripping force applied to the handles, the simple release of the handles when the rocker switch is in the at rest, closed position, initiating the locking as required of the jaws upon the clamped parts, hereinafter termed the workpiece. The operator defining the option of the device being in the locking or unlocked mode by the operation of said rocker switch trigger profile mounted within the finger profiles of the moving handle grip profile. The gripping force of the operated jaws can be further determined by the manufacturers chosen resilient level of the actuation arm resilient bowed portions or alternately actuation arm compression spring, the elastic potential energy. The resultant jaw resilient gripping force is largely proportional to the clenching force applied to the handles and the pivotal dimension ratio between the handles and jaws less any small losses incurred during the switch locking procedure, the fulcrum being the jaw pivot pin.

The invention also includes, in a further iteration in order to provide a more versatile and useful device, a method whereby the interchangeable jaw gripping profiles can be interchanged with other outer jaws with differing gripping profiles in order to provide a cost effective equivalent to several set of differing pliers required for different jobs. These interchangeable jaws being usefully locked or unlocked from robust engagement within the fixed or pivotal jaw stubs as required, providing one locking handle set capable of use with a cost effective range of differing jaws as required.

The detachable interchangeable jaws having corresponding locking blade profiles incorporated within their generally planar outer laminate plates, in best practice the locking blade profiles are formed in a slow curve to aid their robust engagement within the matching pivotal and fixed jaw blade channels. When the chosen interchangeable jaw locking blade profiles are fully inserted within their corresponding jaw stub blade channels, the jaw stub abutment faces further robustly contact the interchangeable jaw abutment faces.

The present invention is further characterized by the fixed and moving jaw stubs having strong permanent magnets fitted within their jaw stub magnet recesses such that said magnets magnetic field can suitably act on the ferrous metal blade tips of the fitted interchangeable jaw locking blade profiles, the said magnets, magnetic force, robustly locking the interchangeable jaw or jaws in place within the said fixed or moving jaw stubs. In order to remove said interchangeable jaw the operator requires to open the pliers and forcefully pull the detachable interchangeable jaw from its corresponding jaw stub blade channel. The use of non-ferrous metal such as stainless steel within the fixed and moving jaw stubs construction around the permanent magnets further ensures the efficient application of the permanent magnets magnetic field providing greater effective retention of the interlocking locking blade profiles of the interchangeable jaws during use.

An even further embodiment of the present invention in order to allow utilization as water pump pliers, said pliers normally having even further opening, gripping jaws, generally at 90 degrees to the fixed handle, characterized wherein the fixed head portion pivotal jaw pin bore is elongated such as to allow the pivotal jaw to usefully swivel open further. The closure of the moving handle towards the fixed handle, first drives the pivotal jaw pin up the corresponding fixed head portion pivotal jaw elongate pin bore towards the fixed jaw, thereby closing the pivotal jaw towards fixed jaw, when said pivotal jaw pin has reached the extent of its travel within the elongate pivotal pin bore it reverts to its pivotal function as previously alluded.

An even further embodiment of the present invention relates to a pliers apparatus whereas there is no handle bowed or compression spring resilient portion incorporated, the said pliers operation still incorporating interchangeable jaws or being switchable between locking and unlocking of the handles.

### BRIEF DESCRIPTION OF THE DRAWINGS

A full and enabling disclosure of the present Invention including the best mode thereof, directed to one of ordinary skill in the art, is set forth in the specification, which makes reference to the appended drawings, in which:

FIG. 1 is a perspective view of a “vice grip” adaptation of the Everyway Pliers in their open position.

FIG. 2 is a perspective view of a “vice grip” adaptation of the Everyway Pliers in their open position whereas the jaws are interchangeable.

FIG. 3 is a perspective close up view of the fixed jaw teeth of the Everyway Pliers the teeth illustrated being out of sequence one laminate to the other, the moving jaw being similarly orientated as required.

FIG. 4 is a plan view of a “vice grip” adaptation of the Everyway Pliers in their open position whereas the jaws are interchangeable. The topmost section of the grips and moving handle and strut top laminates removed in order to illustrate the interaction of the rocker switch and toothed fan in their engaged mode, the toothed fan teeth capable of ratcheting against the switch teeth.

FIG. 5 is a plan view of a “vice grip” adaptation of the Everyway Pliers in their closed, locking function whereas the jaws gripping profiles are applying gripping force to a workpiece. The topmost section of the grips and moving handle and strut top laminates removed in order to illustrate the interaction of the rocker switch and toothed fan in their engaged mode.

FIG. 6 is a plan view of a “vice grip” adaptation of the Everyway Pliers in their release, from locking application whereas the jaws gripping profiles are discharged from gripping pressure upon a workpiece. The topmost section of the grips and moving handle and strut top laminates removed in order to illustrate the interaction of the operated rocker switch and toothed fan in their disengaged mode.

FIG. 7 is a perspective view of the “vice grip” adaptation of the Everyway Pliers, shown dismantled into its constituent parts for display purposes.

FIG. 8 is a perspective view of the “vice grip” adaptation of the Everyway Pliers whereas the jaws are interchangeable, illustrated dismantled into its constituent parts for display purposes.

FIG. 9 is a perspective view of the “water-pump” adaptation of the Everyway Pliers shown in its open position.

FIG. 10 is a plan view of the “water-pump” adaptation of the Everyway Pliers shown in its open position; a workpiece illustrated entering the jaws opening.

FIG. 11 is a plan view of the “water-pump” adaptation of the Everyway Pliers shown in its closed position, a workpiece illustrated gripped within the jaws.

FIG. 12 is a plan view of the “water-pump” adaptation of the Everyway Pliers shown in its open position, the actuation arm utilizing a compression spring.

### REFERENCE TO THE DRAWINGS

Following is a listing of the various components used in the best mode preferred embodiment and alternative embodiments. For the ready reference of the reader the reference numerals have been arranged in ascending numerical order.

| | | | |
|---|---|---|---|
| 1 | Everyway Pliers | 400 | Moving Handle |
| 200 | Fixed Handle | 401 | Moving Handle Proximal End |
| 201 | Fixed Internal Framework | 402 | Moving Handle Central Pivot Bore |
| 202 | Fixed Handle Distil End | 403 | Moving Handle Actuation Arm |
| 203 | Fixed Head Portion | 404 | Moving Handle Actuation Arm Pin Bore |
| 204 | Pivotal Jaw Pin Bore | 405 | Moving Handle Distil End |
| 205 | Pivotal Jaw Pin Elongated Bore | 406 | Actuation Arm Resilient Bowed Portion |
| 206 | Fixed Gripping Jaw | 407 | Actuation Arm Compression Spring |
| 207 | Fixed Jaw Inner Laminate | 408 | Actuation Arm First Overlapping Member |
| 208 | Fixed Jaw Outer Laminate | 409 | Actuation Arm Second Overlapping Member |
| 209 | Fixed Jaw Gripping Profile | 410 | Actuation Arm Overlapping Member Pins |
| 210 | Fixed Jaw Teeth | 411 | Actuation Arm Overlapping Member Spring |
| | | | Stops |
| 211 | Fixed Handle Proximal End | 412 | Moving Handle Main Spring |
| 212 | Fixed Handle Grip | 413 | Moving Handle Grip |
| 213 | Fixed Handle Grip Retaining Slot | 414 | Moving Handle Grip Finger Profiles |
| 214 | Fixed Handle Grip Dowel Holes | 415 | Moving Handle Grip Spacers |
| 215 | Fixed Handle Grip Concave Portion | 416 | Moving Handle Grip Dowel Holes |
| 216 | Fixed Handle Grip Lanyard Bore | 417 | Moving Handle Main Spring Pin Holes |
| 217 | Fixed Handle Jaw Stub | 418 | Moving Handle Rocker Switch Axle Bores |
| 218 | Fixed Jaw Stub Abutment Profiles | 419 | Moving Handle Metal Laminates |
| 219 | Fixed Jaw Stub Blade Channels | 420 | Moving Handle Internal Framework |
| 220 | Fixed Jaw Stub Magnet Recess | 421 | Moving Handle Grip Slots |
| 221 | Fixed Handle To Strut Pin Bore | 422 | Actuation Arm Guide Pin Slots |
| 222 | Fixed Handle Framework Dowel Holes | 423 | Moving Handle Dowel Holes |
| 300 | Pivotal Jaw | 500 | Pivotal Strut |
| 301 | Pivotal Gripping Jaw | 501 | Pivotal Strut Inner End |
| 302 | Pivotal Jaw Pivot Bore | 502 | Pivotal Strut Inner End Pivot Pin Bore |
| 303 | Pivotal Jaw Actuation Pivot Bore | 503 | Pivotal Strut Outer End |
| 304 | Pivotal Jaw Gripping Profile | 504 | Pivotal Strut Outer End Pivot Pin Bore |
| 305 | Pivotal Jaw Gripping Teeth | 505 | Pivotal Strut Outer End Toothed Fan |
| 306 | Pivotal Jaw Laminates | 506 | Pivotal Strut Toothed Fan Teeth |
| 307 | Pivotal Jaw Stub | 507 | Pivotal Strut Fan Spring Hole |
| 308 | Pivotal Jaw Blade Channel | 508 | Pivotal Strut Laminates |
| 309 | Pivotal Jaw Abutment Profiles | | |
| 310 | Pivotal Jaw Magnet Recess | | |
| 600 | Pivotal Jaw Pin | 800 | Force Triangle |
| 601 | Pivotal Jaw Actuation Pivot Pin | 801 | Force Triangle Base |
| 602 | Fixed Handle To Strut Pivot Pin | 802 | Force Triangle Apex |
| 603 | Moving Handle Central Apex Pivot Pin | 803 | Force Triangle First Side |
| 604 | Main Spring Retaining Pin | 804 | Force Triangle Second Side |
| 605 | Assembly Rivets | | |
| 606 | Assembly Dowels | 900 | Interchangeable Jaws |
| 607 | Rivet Holes | 901 | Interchangeable Jaws Locking Blade Profiles |
| | | 902 | Interchangeable Jaws Abutment Profiles |
| | | 903 | Interchangeable Jaws Locking Blade Tips |
| | | 904 | Interchangeable Jaws Gripping Profiles |
| | | 905 | Interchangeable Jaw Magnets |
| 700 | Rocker Switch | 906 | Interchangeable Jaws Inner Laminates |
| 701 | Rocker Switch Closure Spring | 907 | Interchangeable Jaws Outer Laminates |
| 702 | Rocker Switch Trigger Profile | | |
| 703 | Rocker Switch Toothed Arc | CF | Clenching Force |
| 704 | Rocker Switch Toothed Arc Teeth | GF | Gripping Force |
| 705 | Rocker Switch Axles | W | Workpiece |

### DETAILED DESCRIPTION OF THE EMBODIMENTS

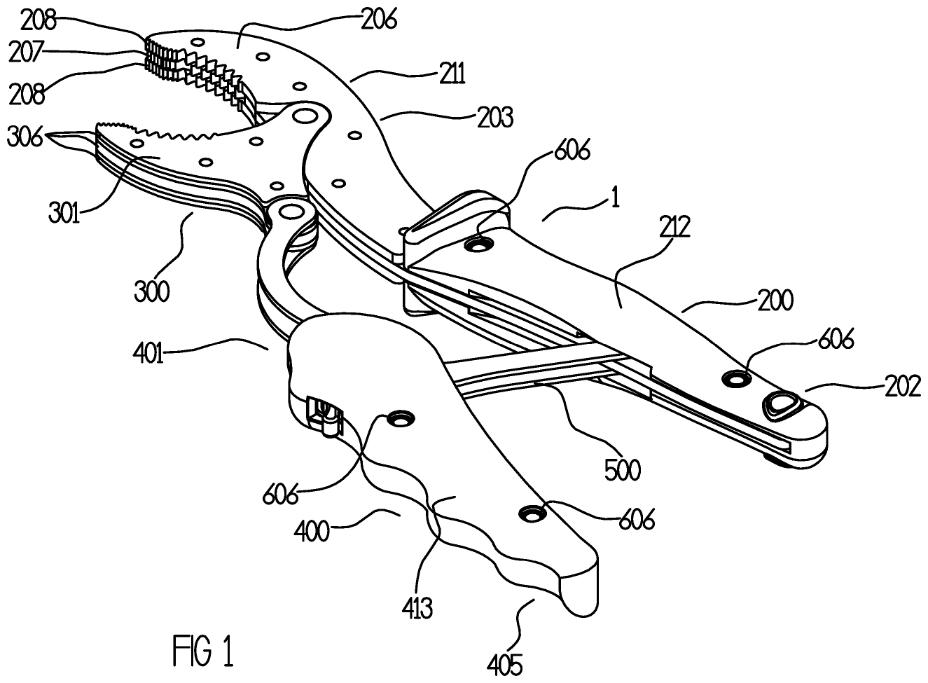

FIGS. 1 and 4 denote the Every Way Pliers 1 at rest,
comprising a fixed handle 200 incorporating fixed internal framework 201, a fixed head portion 203 incorporating the fixed gripping jaw 206 within its proximal end 211 and the fixed handle grip 212 encompassing its distil end 202, said fixed head portion 203 further incorporating a pivotal jaw pin bore 204 and pivotal jaw pin 600 around which a pivotal jaw 300 incorporating the pivotal gripping jaw 301 can swivel towards closure within the same plane when operated by the closure of the moving handle 400 pivotally attached at its moving handle proximal end 401 by the pivotal jaw actuation pivot pin 601, characterised wherein a non-adjustable scalene or Isosceles type force triangle 800 is formed with its force triangle base 801 situated between the pivotal strut 500 inner end 501 pivot pin bore 502, pivotally connected via the fixed handle to strut, pivot pin bore 221, by the fixed handle to strut pivot pin 602 and the pivotal jaw actuation pivot pin 601 pivotal within the moving handle actuation arm pin bore 404 and pivotal jaw actuation pivot bore 303, the triangles apex 802 being formed within the pivotal strut outer pivot bore 504 and corresponding moving handle central pivot pin bore 402 and further incumbent triangle apex pivot pin 603, during use as the operator provides clenching force CF, forcing the moving handle 400 towards the fixed handle 200, the force triangles apex 802, the moving handle central apex pivot pin 603 is propelled towards the force triangle base 801, forcefully elongating said force triangle base 801 line, all the said triangle pivot pin 601, 602, 603 points rotationally fixed within their allotted pivot bores 303, 404, 502, 221, 504, 402, all said pivot pins 601, 602, 603 being pivotal in the same plane, the generally central moving handle strut pivot pin bore 402 is positioned as near as practical to the moving handle proximal end 401 within the moving handle grip 413 such that as clenching force CF is applied between the fixed and moving handle grips 212, 413 the greater part of the finger clenching force CF applied rotates the moving handle grip distil end 405 around the generally central moving handle triangle apex pivot pin 603 towards the fixed handle distil end 202, further rotating the moving handle actuation arm 403 pivotally connected to the pivotal jaw actuation pivot bore and pin 303, 601, away from the fixed main body 200 usefully further forcefully rotating the pivotal jaw 300 towards the closed position around the pivotal jaw pivot pin 600, the combination of said rotational and elongation closure forces employed provide a very efficient heavy duty pliers closure function that can be because of the now greatly reduced distance between the said fixed and moving handles 200, 400 grips 212, 413, be easily operated by one hand or smaller hands.

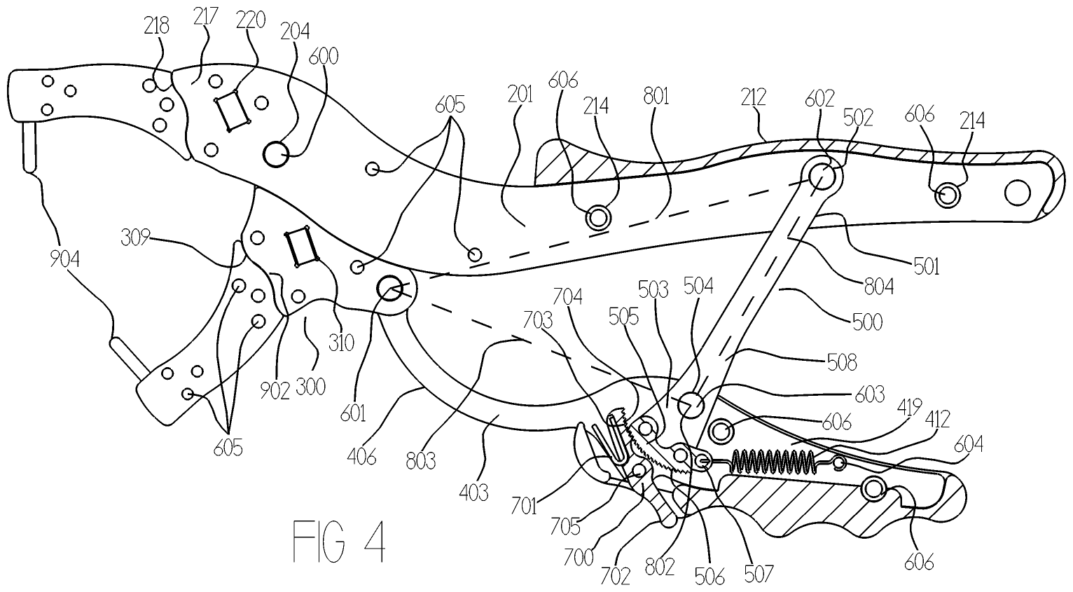

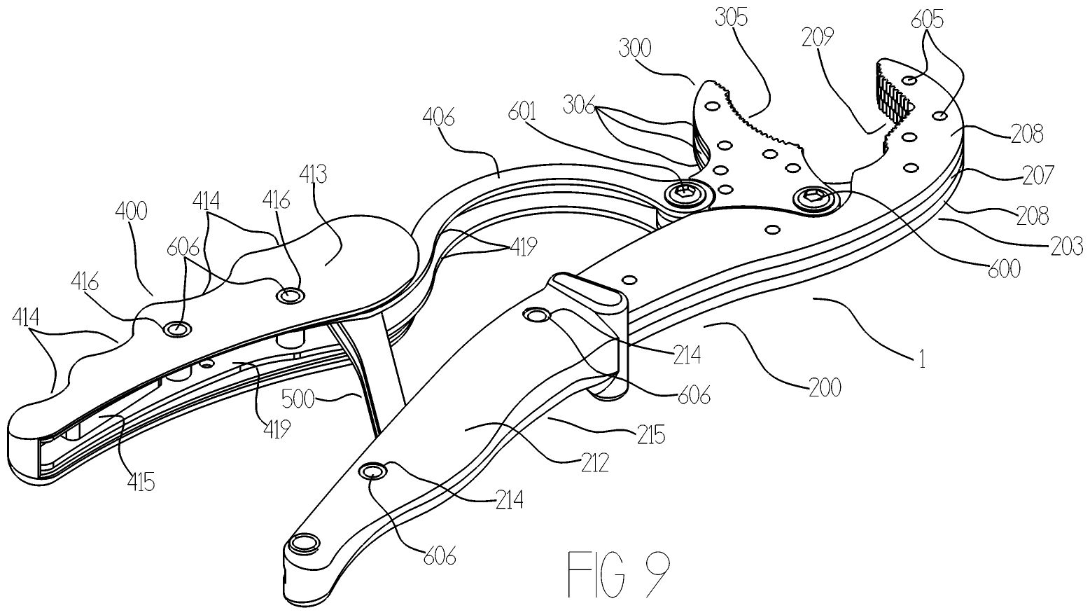

FIGS. 1, 3, 7 and 9 further denote the Every Way Pliers 1 at rest,
where in best practice a laminated construction is utilized, using flat stamped parts riveted together using assembly rivets 605 through assembly rivet holes 607, hereafter termed laminates 207, 208, 419, 906 and 907 whereas when the fixed and or pivotal jaw gripping profiles 209, 304 are variously toothed 210, 305 like in shape, they are further characterized wherein the fixed and or pivotal jaw 206, 300 laminated layers 207, 208, 306 or alternately said gripping profiles 209, 304 teeth 210, 305 are deliberately made out of sequence by up to 50% of the chosen tooth pitch in order to provide a far superior and effective fixed and or pivotal gripping jaw 206, 301 gripping profile 209, 304. The interchangeable jaws 900 inner and outer laminates 906, 907 can also be so arranged. The fixed and moving handles 200, 400 and pivotal strut 500 metal internal framework 201, 420, 508 are in best practice made from stamped flat metal plate with their laminated layers 207, 419, 508 riveted 605 or pinned together, the fixed and moving handle grips 212, 413 in best practice being made from recycled plastic, said handle grips 212, 413 characterized by the fixed and moving handle internal framework 201, 420 engaging into slots 213, 421 within the fixed handle grip 212 and as shown in FIG. 9 the moving handle grip 413 being further specifically engaged by its internal spacer 415 by the internal moving handle internal metal framework 420, which transforms the thin, sideways pliable internal moving handle metal framework 420 into extremely ruggedized fixed and moving handles 200, 400 whilst using the very minimum or absence of assembly rivets 605.

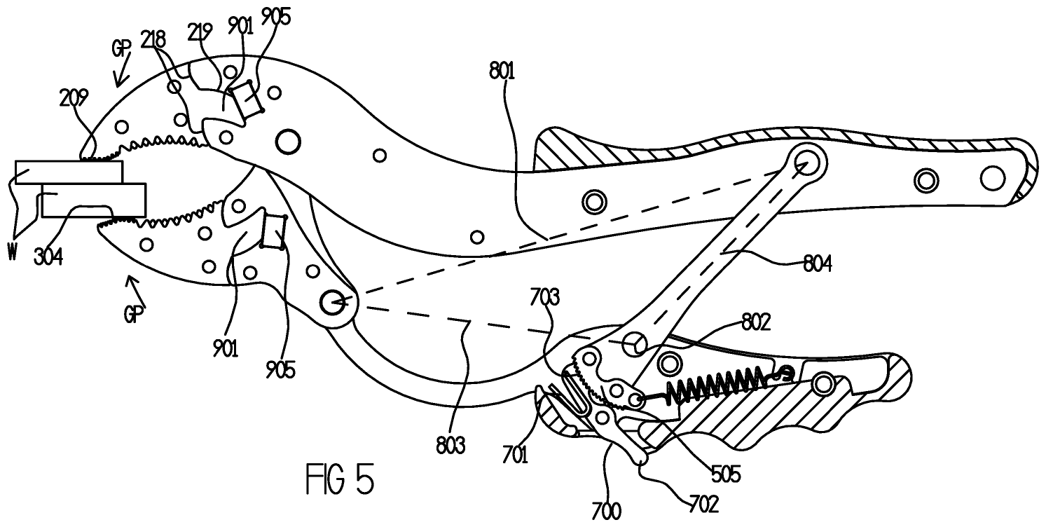

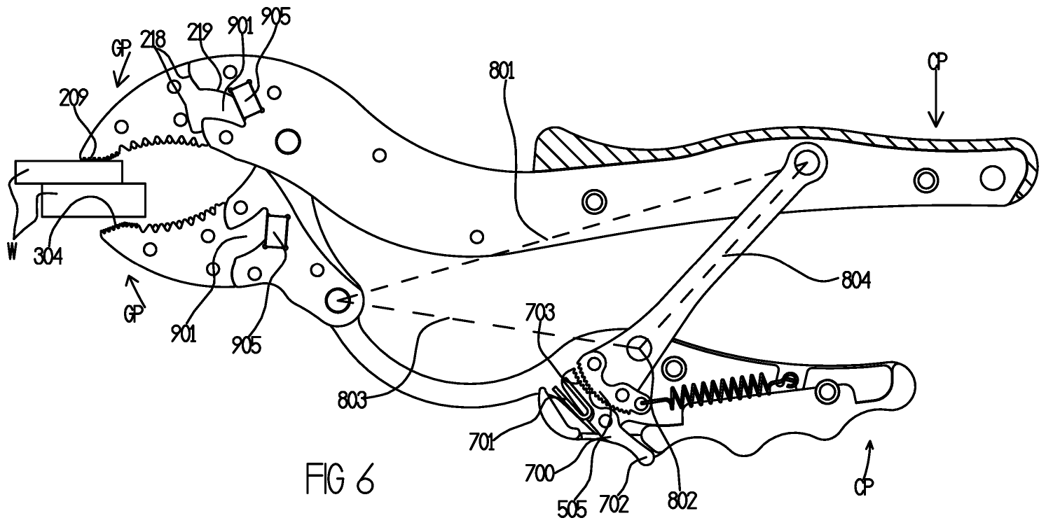

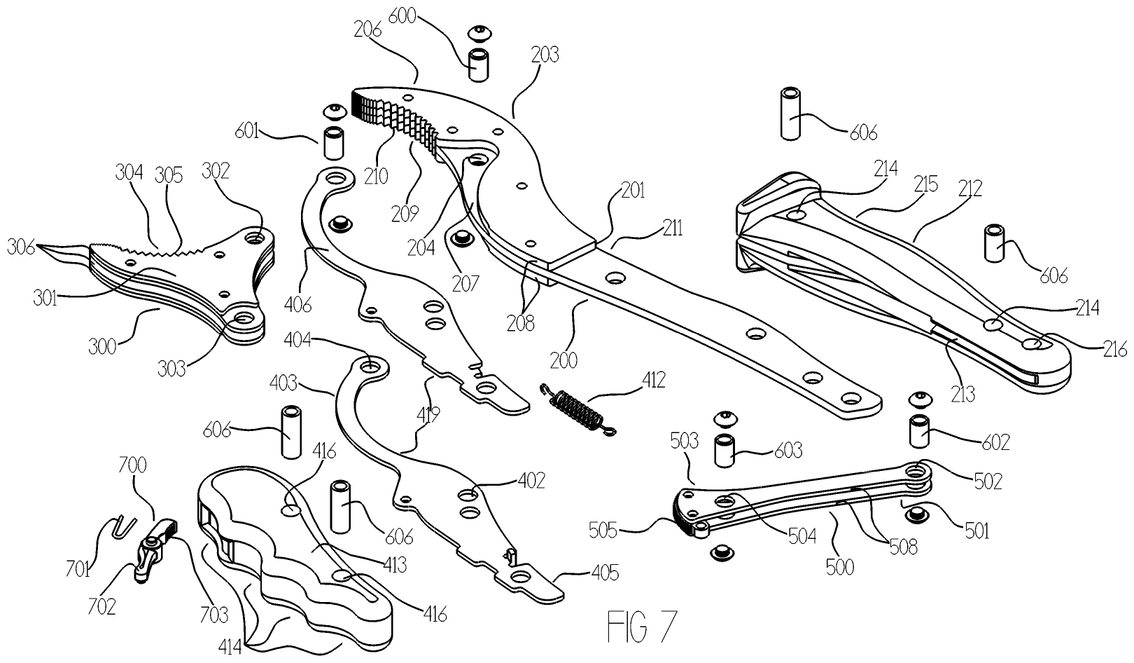

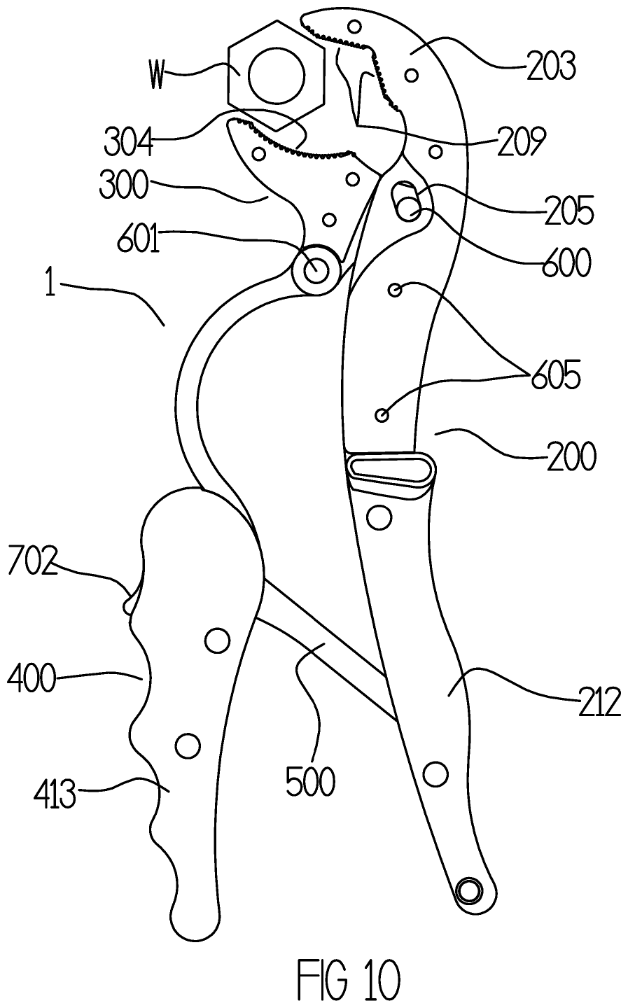

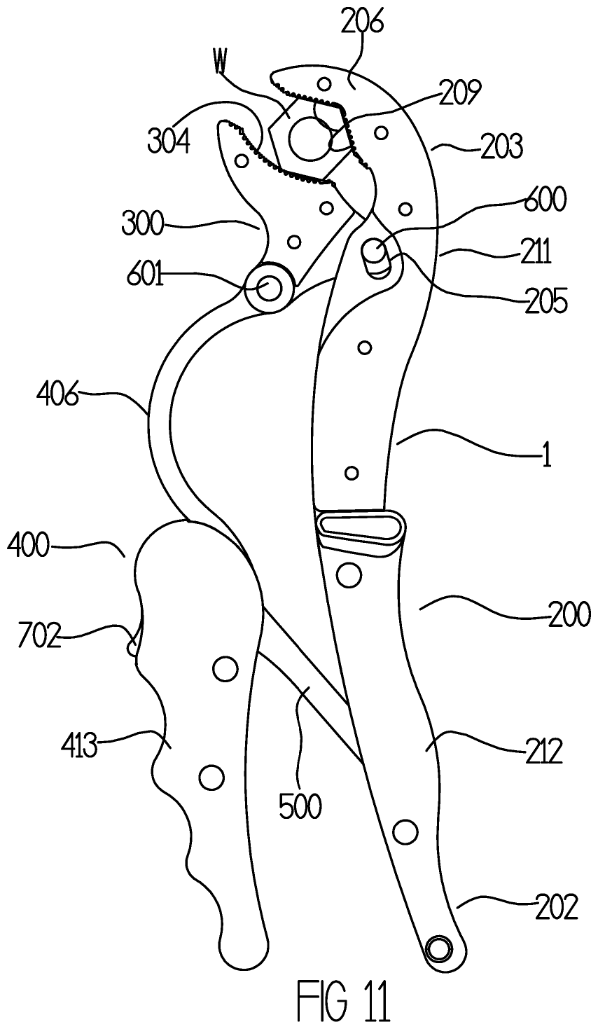

FIG. 1 to 12 and as best illustrated FIG. 9 further denotes the Every Way Pliers 1, wherein the fixed and moving handle grips 212, 413 are specifically ergonomically shaped to provide one handed ease of use by smaller hands, characterized wherein the fixed handle grip 212 has a concave shape portion 215 for contact with the operators web between the thumb and forefinger, the moving handle grip 413 having finger grip profiles 414 formed according to normal corresponding finger lengths from the fixed handle grip 212 giving superior enablement of use by smaller hands.

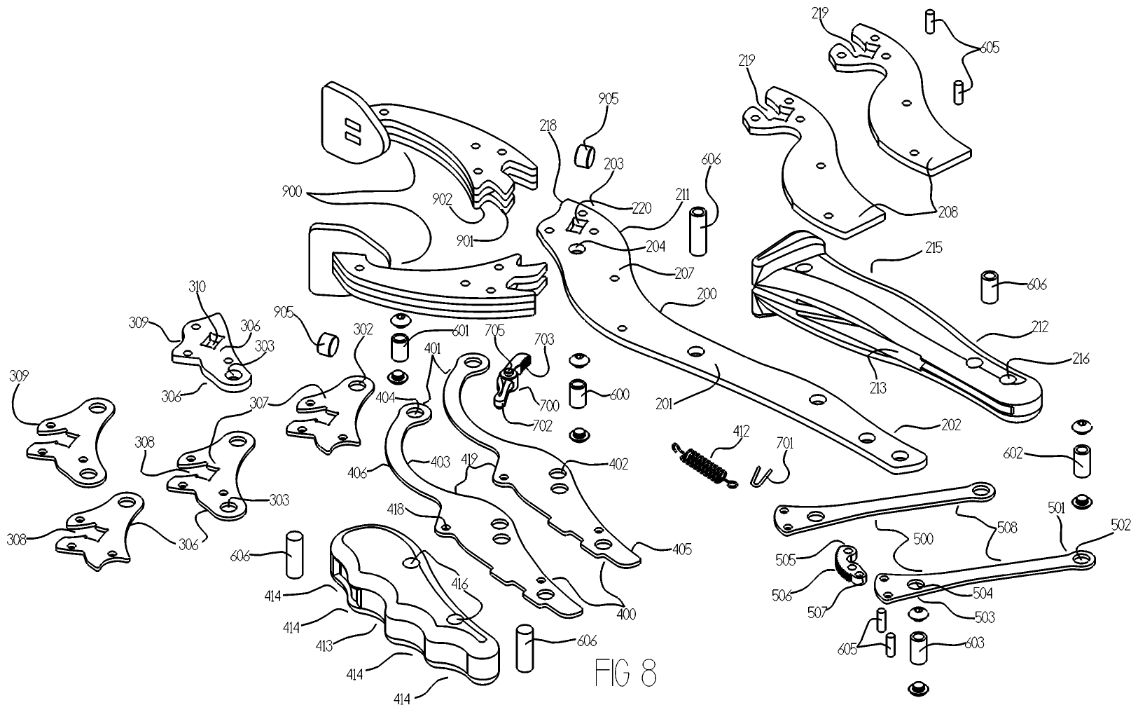

FIG. 1 to 12 and best illustrated in FIGS. 7 and 8 further denoting the Every Way Pliers 1, wherein instead of the fixed and moving handle grips 212, 413 being affixed to the moving and fixed handles 400, 200 by expensive over-moulding, screws, rivets, etcetera, the final assembly is characterized by the use of appropriate lengths of in best practice tube like hollow dowels 606 which when installed are suitably retained by the interaction by the edges of the fixed and moving handle dowel holes 220, 423 of the fixed and moving handle metal internal framework 201, 420 although solid assembly dowels 606 could be used the hollow dowels 606 slightly resilient walls, cost and weight reductions are preferable, this type of extremely cost effective and expedient (9 seconds) final assembly allowing several differing badged, cosmetic or colour, fixed and moving handle grip types 212, 413 as required to be fitted to a uniformly standard fixed or moving handle metal framework 201, 420 prior to despatch to different major sales customers. A safety lanyard bore 216 is further shown utilized in the fixed handle grip 212.

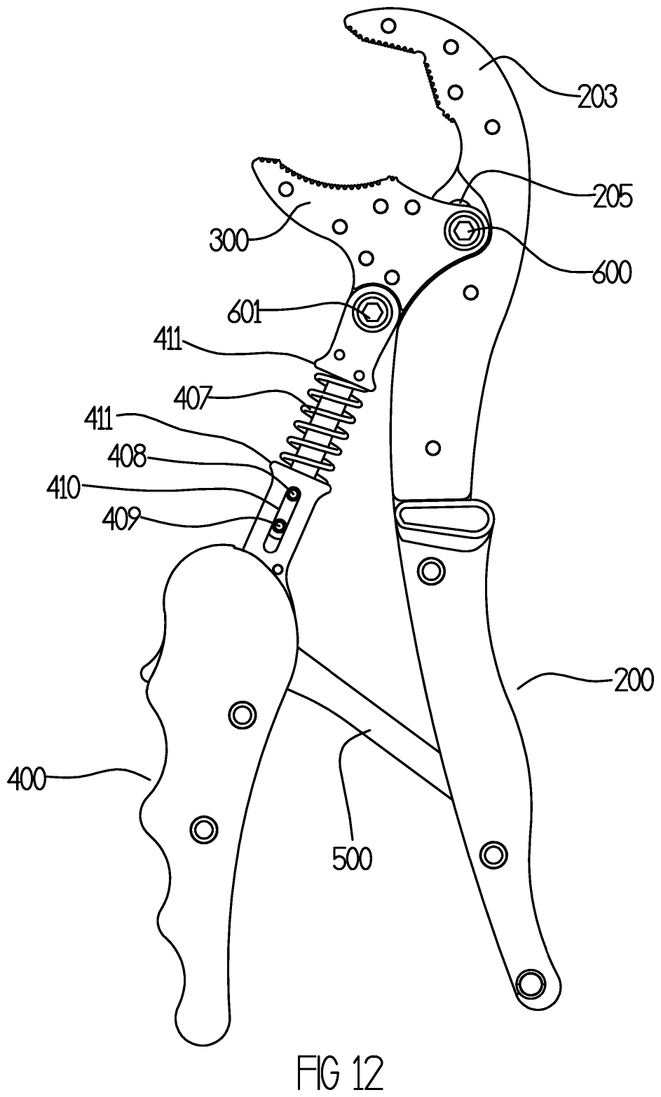

FIG. 1 to 12 illustrate wherein the moving handle actuation arm 403 comprising the said triangle second side 804 can in best practice comprise of a resilient bowed portion 406 which as the fixed and moving handles 200, 400 have clenching force CF applied, further rotating the moving handle actuation arm 403 pivotally connected to the pivotal jaw actuation pivot pin 601, the said resilient bowed portion 406 if bowed outwards from the fixed handle 200 further acts as a resilient means when the appropriate metal type, hardness and thickness is utilized, the moving handle resilient bowed portion 406 acting as an extremely strong spring advantageously allowing the moving handle resilient bowed portion 406 to flex enough to allow the rocker switch toothed arc 703, toothed arc teeth 704 to effectively lock onto further corresponding pivotal strut outer end toothed fan 505 single direction teeth 506, whereas if the closure mechanism was rigid the distance between said pivotal strut toothed fan teeth 506 and rocker switch toothed arc 703 teeth 704 interlocking teeth 506, 704 would be virtually set leading in some circumstances to insufficient clamping force CF upon the clamped workpiece W by the fixed and pivotal jaw gripping profiles 209, 304. FIG. 12 further illustrates an example of use of an actuation arm compression spring 407 between opposing actuation arm overlapping member spring stops 411, actuation arm pins 410 within actuation arm guide pin slots 422 preventing undue flexing of the opposing first and second actuation arm overlapping members 408, 409.

FIG. 1 to 12 and as best illustrated in FIGS. 4, 5 and 6 further denotes the Every Way Pliers 1, wherein the pivotal strut 500 which comprises the force triangles 800 second side 804 situated between the fixed handle to strut pivot pin 602 and the moving handle to strut pivot pin 603 incorporates within the pivotal struts outer end 503 a toothed fan 505 utilizing single direction saw shaped teeth the pivotal strut toothed fan teeth 506, further characterized by the use of in best practice a trigger finger operated, rocker switch 700 trigger profile 702 in best practice situated within the moving handle finger grip profiles 414, said rocker switch 700 having generally central pivotal axles 705 allowing said rocker switch 700 to pivot around corresponding rocker switch axle pivot bores 418 within the moving handle metal internal framework 420, a rocker switch closure spring 701 is further utilized to urge the rocker switch trigger profile 702 outwards in order to propel its opposite toothed arc 703 resiliently into mesh with the correspondingly toothed 506 and profiled, pivotal strut outer end 503 toothed fan 505, in order to construct a low cost heavy duty, ratcheting locking mechanism, the pivotal strut toothed fan teeth 506 utilized further comprising a safety lock as the fixed and pivotal handles 200, 400 require to be clenched at the same clenching force CF used in the workpiece W gripping force GF sequence before and as the said finger operated rocker switch 700 trigger profile 702 is operated, thereby smoothly and safely unlocking the said pliers 1, further characterized in a reduction of parts by the direct inclusion of the trigger profile 702 within the rocker switch 700.

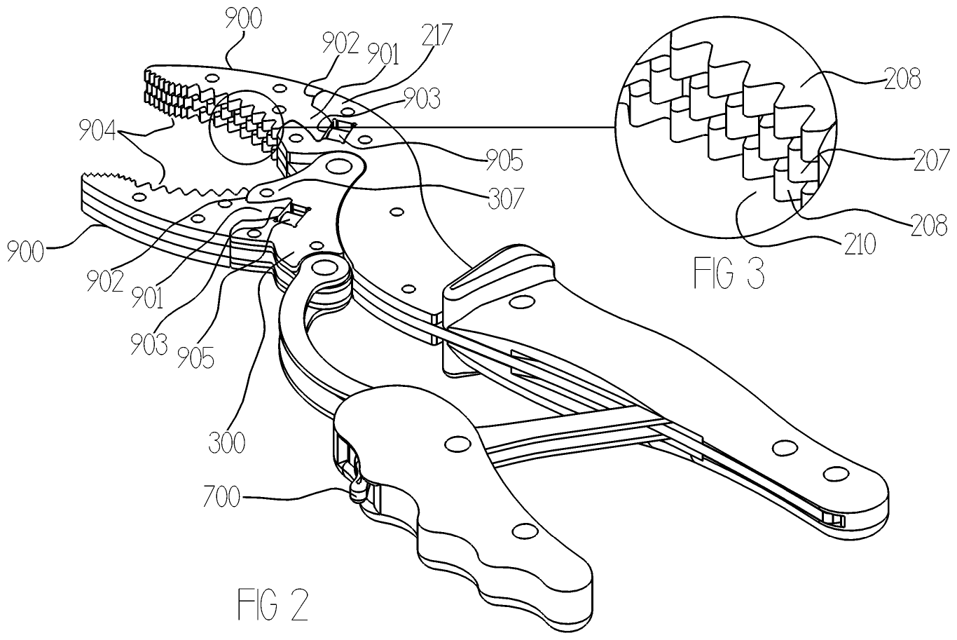

FIG. 2 to 6 and FIG. 8 illustrate wherein, instead of several types of diverse known pliers utilizing integral known single use shaped jaws used for particular differing purposes the Every Way Pliers 1 are capable of fitment of differing interchangeable jaws 900 within abbreviated fixed and pivotal jaw stubs 217, 307 for these differing purposes, all the push fit, interchangeable jaws 900 utilizing near identical interchangeable jaw locking blades and abutment profiles 901, 902 for locking engagement within corresponding fixed and pivotal jaw stub 217, 307 blade channels 219, 308 and abutment profiles 218, 309 within said fixed and pivotal jaw stubs 217, 307 characterized wherein said interchangeable jaws 900 locking blade tips 903 within their corresponding pliers jaw stub 217, 307 blade channels 219, 308 come into contact or near contact with permanent magnets 905 retained within corresponding fixed and pivotal jaw stub 217, 307 magnet recesses 220, 310 which act as an initial locking means until the utilized interchangeable jaws 900 chosen known gripping profiles 904 robustly grip as required the workpiece W which further urge said interchangeable jaw locking blade 901 and abutment profiles 902 into further locking engagement within said corresponding blade channels 219, 308 and abutment profiles 218, 309 within the pliers jaw stubs 217, 307 the permanent magnets 905 securing the interchangeable jaw locking blades 901 within their fixed and pivotal jaw stub 217, 307 interlocking blade channels 219, 310 whilst allowing expedient removal, fitment or change with no further tool requirement or locking switch operation, in order to remove an interchangeable jaw 900 the operator requires to open the every way pliers 1 and forcefully pull the interchangeable jaw 900 from said corresponding jaw stub 217, 307 interlocking blade channel 219, 308. Further characterized wherein the fixed and pivotal jaw stub 217, 307 permanent magnets 905 are held within recesses 220, 310 within said fixed and pivotal jaw stubs 217, 307, in order to give maximum magnetic field connection to the ferrous metal interchangeable jaw 900 locking blade tips 903 with the least magnetic chain effect at the interchangeable jaws gripping profiles 904, the use of non-ferrous metal such as stainless steel within the fixed and pivotal jaw stubs 217, 307 construction around said magnets 905 further ensures greater efficient application of said permanent magnets 905 magnetic field, therefore providing more effective retention of the interchangeable jaws 900 wherein the interlocking interchangeable jaw locking blade profiles 901 are in best practice curved inwards along their length such that as any workpiece W as it is gripped by the interchangeable jaw gripping profiles 904 acts to further propel said interlocking locking blade profiles 902 into the fixed or pivotal jaw stub 217, 307 interlocking locking blade channels 219, 308 usefully forcing the said locking blade profiles 901 into their corresponding jaw locking blade channels 219, 308, wherein the interchangeable jaw abutment profiles 902 robustly adjoin the complementary jaw stub abutment profiles 218, 309.

FIG. 1 to 8 and as best illustrated in FIGS. 9 to 12 further denotes the Every Way Pliers 1, wherein a further embodiment allows utilization as water pump pliers, said pliers 1 normally incorporating gripping jaws 206, 301 generally at 90 degrees relative to the fixed handle 200, characterized wherein the fixed head portion 203 pivotal jaw pin bore 204 is elongated 205 such as to allow the pivotal jaw 300 to usefully swivel further open and the fixed gripping jaw 206 mounted generally at 90 degrees relative to the fixed handle 200, the closure of the moving handle 400 towards the fixed handle 200, first drives the pivotal jaw pin 600 up the corresponding fixed head portion 203 pivotal jaw pin elongated bore 205 towards the fixed gripping jaw 206, thereby closing the pivotal jaw 300 towards fixed gripping jaw 206, when the said pivotal jaw pin 600 has reached the extent of its travel within the pivotal jaw pin elongated bore 205 it reverts to its pivotal function as previously alluded, the optional locking function incorporated, in some circumstances being a substantial benefit.

FIG. 1 to 12 and as best illustrated in FIG. 9, further denotes the Every Way Pliers 1, wherein the fixed and moving handle grips 212, 413 are specifically ergonomically shaped to provide one handed ease of use by smaller hands, characterized wherein the fixed handle grip 212 has a concave shape portion 215 for contact with the operators web between the thumb and forefinger, the moving handle grip 413 having further finger grip profiles 414 formed according to normal corresponding finger lengths from the fixed handle grip 212 giving superior enablement of use by smaller hands.

1. Pliers 1 comprising a fixed handle 200 incorporating a fixed metal internal framework 201, a fixed head portion 203 incorporating the fixed gripping jaw 206 within its proximal end 211 and a fixed handle grip 212 encompassing its distil end 202, said fixed head portion 203 further incorporating a pivotal jaw pin bore 204 and pivotal jaw pin 600 around which a pivotal jaw 300 incorporating the pivotal gripping jaw 301 can swivel towards closure within the same plane when operated by the closure of the moving handle 400 pivotally attached at its moving handle proximal end 401 by the pivotal jaw actuation pivot pin 601, characterised wherein a non-adjustable scalene or Isosceles type force triangle 800 is formed with its force triangle base 801 situated at one end between the pivotal strut 500 inner end 501 pivot pin bore 502 and fixed handle to strut pivot pin bore 221 by the fixed handle to strut pivot pin 602 and at its other end the pivotal jaw actuation pin 601 pivotal within the moving handle actuation arm pin bore 404 and pivotal jaw actuation pivot bore 303, the triangles apex 802 being formed within the pivotal strut outer pivot bore 504 and corresponding moving handle central pivot pin bore 402 and further incumbent force triangle apex pivot pin 603, the force triangle first side 803 formed between the moving handle 400 central apex pivot pin 603 and the pivotal jaw actuation pin 601, the force triangle second side 804 formed within the span of the pivotal strut 500 between its inner end pivot pin 602 bore 502 and its outer end pivot pin 603 bore 504, during use as the operator provides clenching force CF forcing the moving handle 400 towards the fixed handle 200, the force triangles apex 802 the moving handle central apex pivot pin 603, is propelled towards the force triangle base 801, forcefully elongating said force triangle base 801 line, all the said triangle pivot pin 601, 602, 603 points rotationally fixed within their allotted pivot bores 303, 404, 502, 221, 504, 402 said pivot pins 601, 602, 603 being pivotal in the same plane, the generally central moving handle strut pivot pin bore 402 is positioned as near as practical to the moving handle proximal end 401 within the moving handle grip 413 such that as clenching force CF is applied between the fixed and moving handle grips 212, 413 the greater part of the finger clenching force CF applied rotates the moving handle grip distil end 403 around the generally central moving handle triangle apex pivot pin 603, towards the fixed handle distil end 202, further rotating the moving handle actuation arm 403 pivotally connected to the pivotal jaw actuation pivot bore and pin 303, 601, away from the fixed main body 200 further forcefully rotating the pivotal jaw 300 towards the closed position around the pivotal jaw pin 600, the combination of said rotational and elongation closure forces employed provide a very efficient heavy duty pliers closure function that can be because of the now greatly reduced distance between the said fixed and moving handles 200, 400 grips 212, 413 can easily be operated by one hand or smaller hands.

2. Pliers 1 as claimed in claim 1, wherein the pivotal strut 500 which comprises the force triangles 800 first side 803 situated between the fixed handle to strut pivot pin 602 and the moving handle to strut pivot pin 603 incorporates within the pivotal struts outer end 503 a toothed fan 505 utilizing single direction saw shaped teeth 506, further characterized by the use of an in best practice, trigger finger operated, rocker switch 700 in best commercial practice situated within the moving handle finger grip profiles 414, said rocker switch 700 having generally central pivotal axles 705 allowing said rocker switch 700 to pivot around corresponding rocker switch axle pivot bores 418 within the moving handle metal internal framework 420, a rocker switch closure spring 701 is further utilized to urge the rocker switch trigger profile 702 outwards in order to propel its opposite toothed arc 703 resiliently into mesh with the correspondingly toothed 505 and profiled, pivotal strut outer end 503 toothed fan 506, in order to construct a low cost heavy duty, ratcheting locking mechanism, the pivotal strut single direction teeth 506 utilized further comprising a safety lock as the fixed and moving handles 200, 400 require to be clenched at the same clenching force CF used in the workpiece W gripping sequence before and as the said finger operated rocker switch 700 trigger profile 702 is operated, thereby smoothly and safely unlocking the said pliers 1, further characterized in a reduction of parts and costs by the direct inclusion of the trigger profile 702 within the rocker switch 700.

3. Pliers 1 as claimed in any one of the previous claims, wherein in order to further reduce the manufacturing environmental impact to a minimum, the fixed and moving handles internal frameworks 201, 420 are preferably made from stamped flat metal plate with their laminated layers 207, 208, 306, 419, 508 riveted 605 or pinned together, the fixed and moving handle grips 212, 413 in best practice being made from recycled plastic, said handle grips 212, 413 characterized by the fixed and moving handles internal framework 201, 420 engaging into slots 213, 421 within the fixed and moving handle grips 212, 413, the moving handle grip 212, further engaged by its internal spacers 415, transforming the thin, sideways pliable metal moving handle internal framework 420 into extremely ruggedized moving handle 400 whilst using the very minimum or absence of assembly rivets 605.

4. Pliers 1 as claimed in any one of the previous claims, where in best practice a laminated construction is utilized, using flat stamped metal parts riveted together, hereafter termed laminates 207, 208, 306, 419 whereas when the fixed and or pivotal jaw gripping profiles 209, 304 are variously toothed 210, 305 like in shape, characterized wherein the fixed and or pivotal gripping jaws 206, 301 laminated layers 207, 208, 306 said gripping profiles 209, 304 teeth 210, 305 are deliberately made out of sequence by up to 50% of the chosen tooth pitch in order to provide a far superior and effective fixed and or pivotal gripping jaw 206, 301 gripping profile 209, 304.

5. Pliers 1 as claimed in any one of the previous claims, wherein the fixed and moving handle grips 212, 413 are specifically ergonomically shaped to provide one handed ease of use by smaller hands, characterized wherein the fixed handle grip 212 has a concave shape portion 215 for contact with the operators web between the thumb and forefinger, the moving handle grip 413 having further finger grip profiles 414 formed according to normal corresponding finger lengths from the fixed handle grip 212 giving superior enablement of use by smaller hands.

6. Pliers 1 as claimed in claim 2, characterized wherein if the finger operated rocker switch 700 trigger profile 702 is compressed whilst the fixed and moving handles 201,400 are clenched the Pliers 1 can be further conveniently utilized as non-locking pliers.

7. Pliers 1 as claimed in previous claims, wherein instead of the fixed and moving handle grips 212, 413 being affixed to the moving and fixed handles 200, 400 by expensive over-moulding, screws, rivets, etcetera, the final assembly is characterized by the use of appropriate lengths of in best practice tube like hollow dowels 606 which when installed are suitably retained by the interaction by the edges of the fixed and moving handle dowel holes 222, 423 of the fixed and moving handle internal framework 201, 420 although solid assembly dowels 606 could be used the hollow dowels 606 slightly resilient walls, cost and weight reductions are preferable, this type of extremely cost effective and expedient (under 10 seconds) final assembly allowing several differing badged, cosmetic or colour, fixed and moving handle grip types 212, 413 as required to be fitted to a uniformly standard fixed or moving handle internal framework 201, 420 prior to despatch to different major sales customers.

8. Pliers 1 as claimed in any one of the previous claims, characterized wherein the moving handle actuation arm 403 comprising the said force triangle second side 804 can further comprise of a resilient bowed portion 406 which as the fixed and moving handles 200, 400 have clenching force CF applied, further rotating the moving handle actuation arm 403 pivotally connected to the pivotal jaw actuation pivot pin 601, the said resilient bowed portion 406 when bowed outwards from the fixed handle 200, further acting as a resilient means when the appropriate metal type, hardness and thickness is utilized, the actuation arm resilient bowed portion 406 acting as an extremely strong spring advantageously allowing the actuation arm resilient bowed portion 406 to flex enough to allow the rocker switch toothed arc 703, toothed arc teeth 704 to beneficially lock onto further corresponding pivotal strut toothed fan 505 teeth 506, whereas if the closure mechanism was rigid the distance between said pivotal strut toothed fan teeth 506 and rocker switch toothed arc 703 teeth 704 interlocking teeth 506, 704 would be virtually set, leading in some circumstances to insufficient gripping force GF upon the clamped workpiece W by the fixed and pivotal jaw gripping profiles 209, 304.

9. Pliers 1 as claimed in any one of the previous claims, wherein instead of several types of diverse known pliers utilizing integral known single use shaped jaws used for particular differing purposes the Every Way Pliers 1 are capable of fitment of differing interchangeable jaws 900 within abbreviated fixed and pivotal jaw stubs 217, 307 for these differing purposes, all the push fit, interchangeable jaws 900 utilizing near identical locking blade and abutment profiles 901, 902 for locking engagement within corresponding fixed and pivotal jaw stub 217, 307 blade channels 219, 308 and abutment profiles 218, 309 within said fixed and pivotal jaw stubs 217, 307 characterized wherein when said interchangeable jaws 900 locking blade tips 903 within their corresponding pliers jaw stub 217, 307 blade channels 219, 308 come into contact or near contact with permanent magnets 905 retained within corresponding fixed and pivotal jaw stub 217, 307 magnet recesses 220, 310 they act as an initial locking means until the utilized interchangeable jaws 900 chosen known gripping profiles 904 robustly grip as required the workpiece W which urges said interchangeable jaw locking blades and abutment profiles 901, 902 into further locking engagement within said corresponding fixed and moving jaw stub abutment profiles and blade channels 218, 219, 308, 309 the magnets 905 securing the interchangeable jaw locking blades 901 within their fixed and pivotal jaw stub 217, 307 interlocking blade channels 219, 310 whilst allowing expedient removal, fitment or change with no further tool requirement or switch operation, in order to remove a interchangeable jaw 900 the operator requires to open the every way pliers 1 and forcefully pull the interchangeable jaw 900 from said corresponding jaw stub 217, 307 interlocking blade channel 219, 308.

10. Pliers as claimed in claim 9, characterized wherein the fixed and pivotal jaw stub 217, 307 magnets 905 are held within recesses 220, 310 within said fixed and pivotal jaw stubs 217, 307, in order to give maximum magnetic field connection to the ferrous metal interchangeable jaw 900 locking blade tips 903 with the least magnetic chain effect at the interchangeable jaws 900 gripping profiles 904, the use of non-ferrous metal such as stainless steel within the fixed and pivotal jaw stubs 217, 307 construction around said magnets 905 further ensures greater efficient application of said magnets 905 magnetic field providing more effective retention of the interchangeable jaws 900 during use.

11. Pliers as claimed in claim 9 wherein the interlocking interchangeable jaw locking blade profiles 901 are in best practice curved inwards along their length such that as any workpiece W as it is gripped by the interchangeable jaw gripping profiles 904 acts to further propel said interlocking locking blade profiles 901 into the fixed or pivotal jaw stub 217, 307 interlocking locking blade channels 219, 308 usefully forcing the said locking blade profiles 901 into their corresponding jaw locking blade channels 219, 308, wherein the interchangeable jaw abutment profiles 902 robustly adjoin the complementary jaw stub abutment profiles 218, 309.

12. Pliers 1 as claimed in as any one of the preceding claims, comprising clamping widths within its specification that are automatically adjusted, the locking gripping force GF can be furthermore determined by the operator by the straightforward gripping force GF applied to the fixed and moving handle grips 212, 413, the uncomplicated release of the fixed and moving handles 200, 400, when the rocker switch 700 is in the closed position initiating the locking if required of the fixed and pivotal gripping jaws 206, 301 upon the workpiece W or clamped parts, the operator defining the option of the everyway pliers 1 being in the locking or unlocked mode by the positioning of the said rocker switch 700.

13. Pliers 1 as claimed in as any one of the preceding claims, characterised by an arc shaped actuation arm resilient bowed portion 406 or alternately a strong compression spring 407 held laterally around apposing overlapping lengthwise members 408, 409 incorporating overlapping member spring stops 411, which act against the said strong compression spring 407 ends, the overlapping lengthwise members being capable of sliding against one another when in use said compression spring 407 is compressed or released, the chosen moving handle actuation arm 403 resilient portion 406, 407 is in best practice incorporated within the moving handle actuation arm portion 403.

14. Pliers 1 as claimed in as any one of the preceding claims, wherein a further embodiment allows utilization as water pump pliers, said pliers 1 normally incorporating gripping jaws 206, 301 generally at 90 degrees relative to the fixed handle 200, characterized wherein the fixed head portion 203 pivotal jaw pin bore 204 is elongated 205 such as to allow the pivotal jaw 300 to usefully swivel further open and the fixed gripping jaw 206 mounted generally at 90 degrees relative to the fixed handle 200, the closure of the moving handle 400 towards the fixed handle 200, first drives the pivotal jaw pin 600 up the corresponding fixed head portion 203 pivotal jaw elongated pin bore 205 towards the fixed gripping jaw 206, thereby closing the pivotal jaw 300 towards fixed gripping jaw 206, when the said pivotal jaw pin 600 has reached the extent of its travel within the pivotal jaw pin elongated bore 205 it reverts to its pivotal function as previously alluded.

15. Pliers 1 as claimed in claim 5 or 14 wherein these embodiments allow further utilization as locking water pump pliers capable of use by small hands.

16. Pliers 1 as claimed in as any one of the preceding claims, wherein there is no handle bowed or compression spring resilient portion incorporated, the said pliers operation still incorporating interchangeable jaws or being switchable between locking and unlocking of the handles.

17. Pliers comprising:
a fixed jaw handle having a fixed jaw located at a first end thereof;
a movable jaw pivotally connected with said fixed jaw handle for pivoting movement towards and away from said fixed jaw;
a movable jaw handle pivotally connected with said movable jaw by a first fixed pivot pin for causing said pivoting movement of said movable jaw towards said fixed handle; and
a strut extending between said fixed jaw handle and said movable jaw handle,
wherein a first end of said strut is connected with said fixed jaw handle by a second fixed pivot pin fixed to said movable jaw handle and a second end connected with said movable jaw handle by a third fixed pivot pin fixed to said movable jaw handle, and
wherein said first, second and third fixed pivot pins define an imaginary triangle having a base extending between said first and second fixed pivot pins and an apex defined by said third fixed pivot pin, the fixed pivot pins being configured such that, in use, when said movable jaw handle is pivoted towards said fixed jaw handle said first fixed pivot pin is moved away from said fixed jaw handle to cause said movable jaw to pivot towards said fixed jaw, said apex defined by said third pivot pin moves towards said base, which base lengthens as said first fixed pivot pin moves away from said fixed jaw handle.

18. Pliers as claimed in claim 17, wherein said second end of said strut is provided with a plurality of teeth and further comprising a switch fitted to said movable jaw handle, said switch being engageable with said plurality of teeth to limit movement of said movable jaw.

19. Pliers as claimed in claim 18, further comprising a spring provided on said movable jaw handle and configured to bias said switch into engagement with said plurality of teeth.

20. Pliers as claimed in claim 18 or 19, further comprising a spring connected with said second end of said strut and said movable jaw handle and configured to pull said second end of said strut away from said switch.

21. Pliers as claimed in any one of claims 17 to 20, wherein said movable jaw handle comprises an arcuate end portion extending from said first fixed pivot pin to a main body portion of said movable jaw handle and said third fixed pivot pin is fixed to said main body portion.

22. Pliers as claimed in any one of claims 17 to 21, wherein said first, second and third fixed pivot pins are disposed in the same plane.

23. Pliers as claimed in any one of claims 17 to 22, wherein at least one of:
i) said fixed jaw comprises a fixed jaw stub fixed to said fixed jaw handle and a gripping member releasably fitted on a projection that projects from said fixed jaw stub; and
ii) said movable jaw comprises a movable jaw stub pivotally connected to said fixed handle by said first fixed pivot pin and a gripping member releasably fitted on a projection that projects from said movable jaw stub.
